(19) United States
(12) Patent Application Publication
(10) Pub. No.: US 2008/0106785 A1
(43) Pub. Date: May 8, 2008

(54) Segmenting Method For Preparing A Periodically Poled Structure

(75) Inventors: Tsai-Hau Hong, Hsinchu (TW); Tze-Chia Lin, Hsinchu (TW); Ming-Hsien Chou, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: HC PHOTONICS CORP., Hsinchu (TW)

(21) Appl. No.: 11/557,907

(22) Filed: Nov. 8, 2006

(51) Int. Cl. G02F 1/35

(52) U.S. Cl. 359/326

(57) ABSTRACT

A method for preparing a periodically poled structure comprises the steps of applying a predetermined voltage to first conductive blocks on a ferroelectric substrate such that a plurality of first domains having a first polarization direction are formed in the ferroelectric substrate and applying the predetermined voltage to second conductive blocks on the ferroelectric substrate such that a plurality of second domains having the first polarization direction are formed in the ferroelectric substrate between the first domains. In addition, the method may further comprises a step of applying the predetermined voltage to a third conductive blocks between the first conductive blocks and the second conductive blocks such that a plurality of third domains having the first polarization direction are formed in the ferroelectric substrate between the first domains and the second domains.

### BACKGROUND OF THE INVENTION

(A) Field of the Invention

The present invention relates to a method for preparing a periodically poled structure, and more particularly, to a segmenting method for preparing a periodically poled structure by segmenting a poling process into a plurality of sub-poling processes on two opposite surfaces of a ferroelectric single crystal.

(B) Description of the Related Art

The periodically poled structure having poled domains in a ferroelectric single crystal such as lithium niobate (LiNbO₃), lithium tantalite (LiTaO₃) and potassium titanyl phosphate (KTiOPO₄) may be widely used in the optical fields such as optical storage and optical measurement. There are several methods for preparing the periodically poled structure such as the proton-exchanging method, the electron beam-scanning method, the electric voltage applying method, etc.

U.S. Pat. No. 6,002,515 discloses a method for manufacturing a polarization inversion part on a ferroelectric crystal substrate. The polarization inversion part is prepared by steps of applying a voltage in the polarization direction of the ferroelectric crystal substrate to form a polarization inversion part, conducting a heat treatment for reducing an internal electric field generated in the substrate by the applied voltage, and then reinverting polarization in a part of the polarization inversion part by applying a reverse direction voltage against the voltage that was previously applied. In other words, the method for preparing a polarization inversion part disclosed in U.S. Pat. No. 6,002,515 requires performing the application of electric voltage twice.

U.S. Pat. No. 6,353,495 discloses a method for forming an optical waveguide element. The disclosed method forms a convex ridge portion having a concave portion on a ferroelectric single crystalline substrate, and a ferroelectric single crystalline film is then formed in the concave portion. A comb-shaped electrode and a uniform electrode are formed on a main surface of the ferroelectric single crystalline substrate, and electric voltage is applied to these two electrodes to form a ferroelectric domain-inverted structure in the film in the concave portion.

U.S. Pat. No. 6,836,354 discloses a method for producing an optical waveguide by irradiating a laser beam onto an oxide single crystal material. The laser beam is irradiated onto an oxide single crystal to form an optical waveguide portion defined by laser working faces, which are then subjected to a wet etching process using, for example, a strong alkaline solution.

U.S. Pat. No. 6,631,231 discloses a method for preparing an optical waveguide element. A ridge-type optical waveguide is joined to a surface of a substrate via a joining layer made of an amorphous material. Two grooves are formed to shape an optical waveguide of a ridge type structure using a dicing device or a laser-working device, and a machining-type dicing is preferred.

However, as the period of the poled domains of the periodically poled structure shrinks, the above-mentioned conventional methods for preparing the poled domains cannot meet precision requirements. In addition, the above-mentioned conventional methods for preparing the poled domains also face difficulties for a periodic period poling.

### SUMMARY OF THE INVENTION

One aspect of the present invention provides a segmenting method for preparing a periodically poled structure by segmenting a poling process into a plurality of sub-poling processes on a ferroelectric single crystal, which can precisely control the width of the poled domains of the periodically poled structure.

A method for preparing a periodically poled structure according to this aspect of the present invention comprises the steps of forming a plurality of tunnels in a ferroelectric substrate, forming a plurality of first conductive blocks and second conductive blocks in the tunnels, applying a predetermined voltage to the first conductive blocks such that a plurality of first domains having a first polarization direction are formed in the ferroelectric substrate and applying the predetermined voltage to the second conductive blocks such that a plurality of second domains having the first polarization direction are formed in the ferroelectric substrate between the first domains. The first conductive blocks and the second conductive blocks are positioned in an interlaced manner, and preferably the first conductive blocks and the second conductive blocks are positioned in an equally-spaced manner. In addition, the method may further comprise a step of applying the predetermined voltage to a third conductive blocks between the first conductive blocks and the second conductive blocks such that a plurality of third domains having the first polarization direction are formed in the ferroelectric substrate between the first domains and the second domains.

Another aspect of the present invention provides a method for preparing a periodically poled structure that comprises the steps of positioning an electrode element to a first contact position of a ferroelectric substrate, applying a predetermined voltage to the electrode element such that a plurality of first domains having a first polarization direction are formed in the ferroelectric substrate, positioning the contact element to a second contact position of the ferroelectric substrate, and applying the predetermined voltage to the electrode element such that a plurality of second domains having the first polarization direction are formed in the ferroelectric substrate between the first domains. Furthermore, the method may further comprise the steps of positioning the contact element to a third contact position of the ferroelectric substrate, the third contact position being between the first contact position and the second contact position and applying the predetermined voltage to the electrode element such that a plurality of third domains having the first polarization direction are formed in the ferroelectric substrate between the first domains and the second domains.

### BRIEF DESCRIPTION OF THE DRAWINGS

The objectives and advantages of the present invention will become apparent upon reading the following description and upon reference to the accompanying drawings in which:

FIG. 1 to FIG. 11 illustrate a method for preparing a periodically poled structure according to a first embodiment of the present invention;

FIG. 12 to FIG. 18 illustrate a method for preparing a periodically poled structure according to a second embodiment of the present invention;

FIG. 19 and FIG. 22 illustrate a method for preparing a periodically poled structure according to a third embodiment of the present invention; and

FIG. 23 illustrates a method for preparing a periodically poled structure according to a fourth embodiment of the present invention.

### DETAILED DESCRIPTION OF THE INVENTION

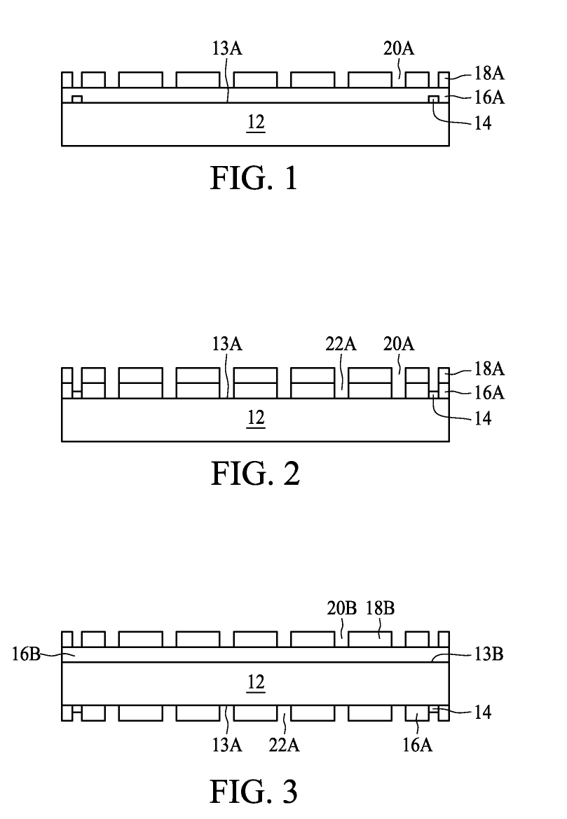

FIG. 1 to FIG. 11 illustrate a method for preparing a periodically poled structure 10 according to a first embodiment of the present invention. An oxide layer 16A is formed on a top surface 13A of a ferroelectric substrate 12 having alignment marks 14, and a photoresist layer 18A having a plurality of openings 20A is then formed on the oxide layer 16A. Subsequently, an etching process is performed using the photoresist layer as an etching mask to remove a portion of the oxide layer 16A not covered by the photoresist layer 18A, i.e., the portion of the oxide layer 16A under the openings 20A, to form a plurality of openings 22A in the oxide layer 16A, as shown in FIG. 2. For example, the etching process can be a wet etching process using a buffered oxide etchant such as buffered hydrofluoric acid.

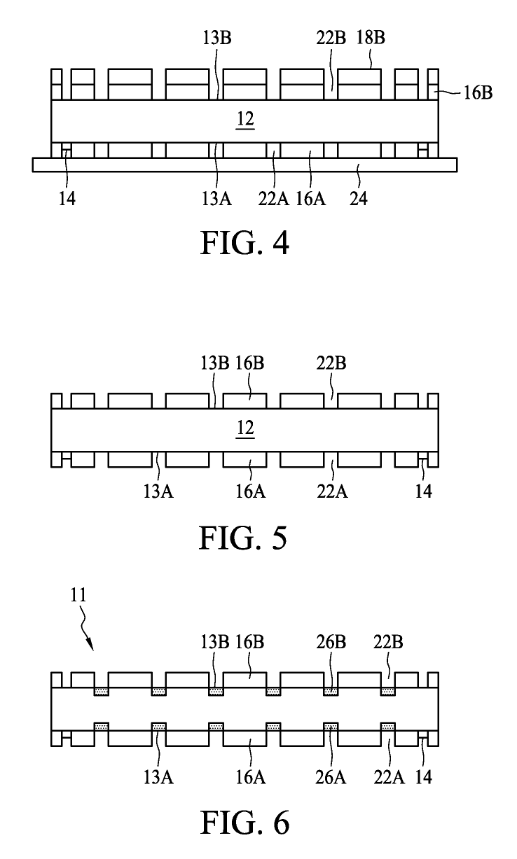

Referring to FIG. 3, which is upside down compared to FIG. 2, the photoresist layer 18A is removed from the surface of the oxide layer 16A by a lift-off process, an oxide layer 16B is formed on a bottom surface 13B of the ferroelectric substrate 12, and a photoresist layer 18B having a plurality of openings 20B is then formed on the oxide layer 16B with reference to the alignment marks 14 on the top surface 13A of the ferroelectric substrate 12 such that the openings 22A in the oxide layer 16A are aligned with the opening 20B in the photoresist layer 18B. Subsequently, an oxide etchant protective layer 24 is used to isolate the oxide layer 16A and the openings 22A from the environment, and an etching process is then performed to remove a portion of the oxide layer 16B using the photoresist layer 18B as an etching mask to form a plurality of openings 22B in the oxide layer 16B, as shown in FIG. 4. Referring to FIG. 5, the etchant protection layer 24 is removed from the oxide layer 16A and the photoresist layer 18B is removed from the oxide layer 16B by the lift-off process. The wafer 11 including the ferroelectric substrate 12 and the layers thereon are emerged in a proton-containing solution such as benzoic acid solution, such that protons in the proton-containing solution diffuse into the ferroelectric substrate 12 through the openings 22A in the oxide layer 16A and the openings 22B in the oxide layer 16B to form a plurality of diffusion regions 26A and 26B in the ferroelectric substrate 12, respectively, as shown in FIG. 6.

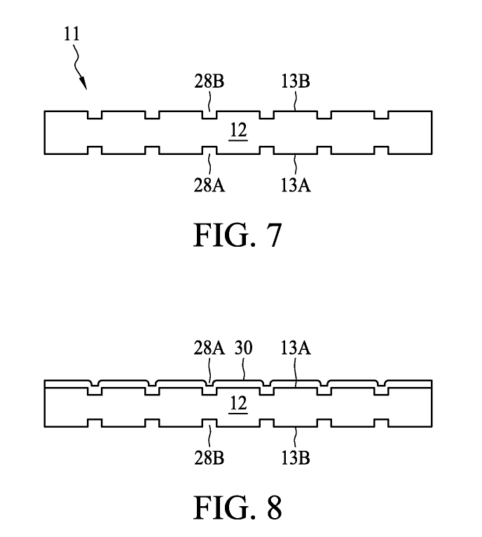

Referring to FIG. 7, the wafer 11 then undergoes an etching process. The etching method can be either dry etching or wet etching. For the wet etching method, the wafer 11 is dipped in a buffered oxide etchant solution such as buffered hydrofluoric acid to perform a wet etching process such that the oxide layers 16A and 16B are entirely removed from the top surface 13A and the bottom surface 13B, respectively, of the ferroelectric substrate 12. In addition, the buffered oxide etchant also selectively removes a portion of the ferroelectric substrate 12, i.e., the diffusion regions 26A on the top surface 13A and the diffusion regions 26B on the bottom surface 13B. Because the etching rate of the buffered oxide etchant to the diffusion regions 26A and 26B is higher than that to the ferroelectric substrate 12, a plurality of tunnels 28A and 28B are formed in an equal interval manner on the top surface 13A and on the bottom surface 13B, respectively, of the ferroelectric substrate 12. Subsequently, a conductive layer 30 covering the top surface 13A of the ferroelectric substrate 12 and the tunnels 28A is formed by a deposition process, as shown in FIG. 8. The conductive layer 30 can be made of conductive material such as nickel, chrome or combinations thereof.

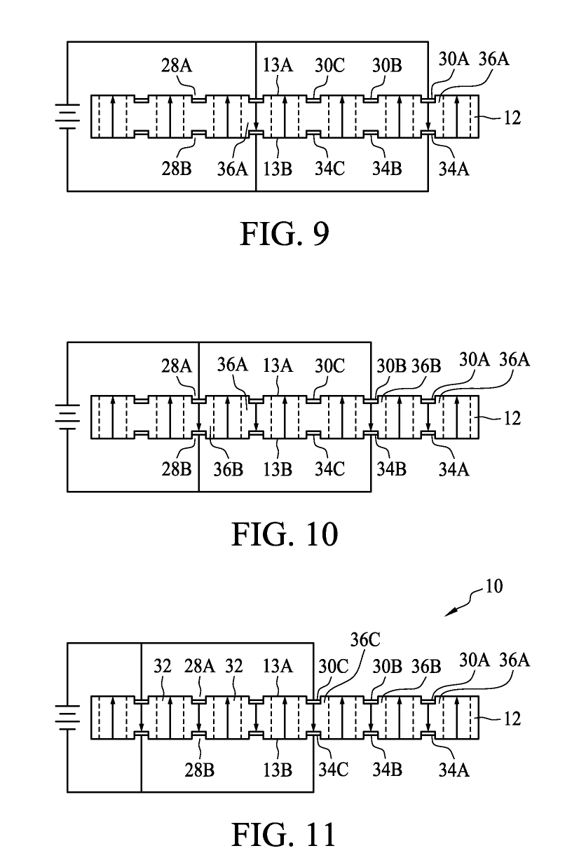

Referring to FIG. 9, a portion of the conductive layer 30 is removed from the top surface 13A of the ferroelectric substrate 12 by a polishing process, while the other portion of the conductive layer 30 remaining in the tunnels 28A forms a plurality of conductive blocks 30A, 30B and 30C in the tunnels 28A. Similar processes are then performed to form a plurality of conductive blocks 34A, 34B and 34C in the tunnels 28B. Subsequently, a predetermined voltage is applied to the conductive blocks 30A in the tunnels 28A and the conductive blocks 34A in the tunnels 28B to form a plurality of first domains 36A in the ferroelectric substrate 12.

Referring to FIG. 10 and FIG. 11, the predetermined voltage is then applied to the conductive blocks 30B in the tunnels 28A and the conductive blocks 34B in the tunnels 28B to form a plurality of first domains 36B in the ferroelectric substrate 12. Again, the predetermined voltage is applied to the conductive blocks 30C in the tunnels 28A and the conductive blocks 34C in the tunnels 28B to form a plurality of first domains 36C in the ferroelectric substrate 12 to complete the periodically poled structure 10. The periodically poled structure 10 comprises a plurality of first domains 30A, 30B and 30C having a first polarization direction in the ferroelectric substrate 12 and a plurality of second domains 32 interleaved between the first domains 32A, 32B and 32C in the ferroelectric substrate 12, which can be used as a quasi-phase matching structure. The entire ferroelectric substrate 12 originally possesses a polarization direction the same as the second polarization, but the applied voltage partially inverts the polarization direction of the ferroelectric substrate 12. In particular, the first polarization direction is substantially opposite to the second polarization direction. In conclusion, the poling process is segmented into two sub-poling processes, which can precisely control the width of the poled domains of the periodically poled structure 10.

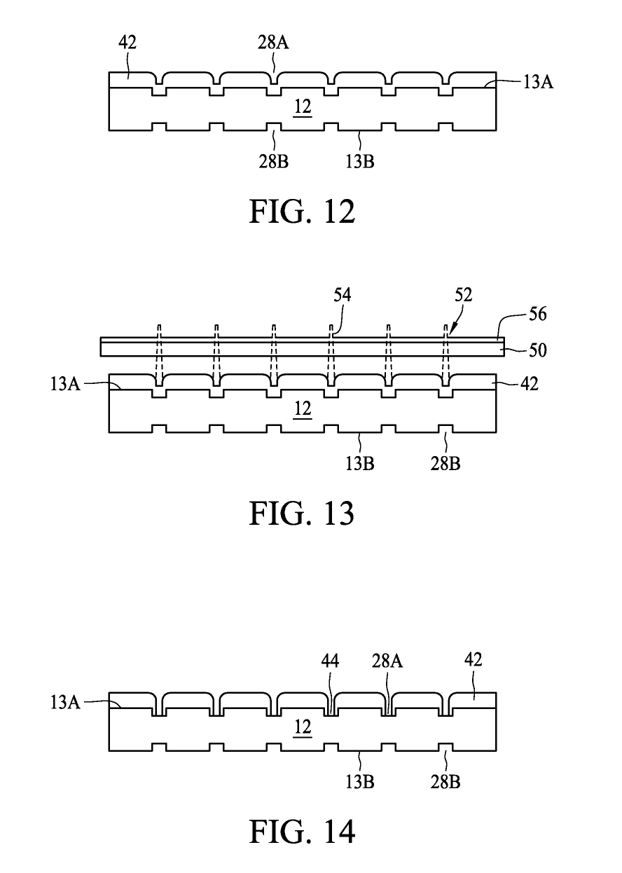

FIG. 12 to FIG. 18 illustrate a method for preparing a periodically poled structure 40 according to a second embodiment of the present invention. The processes shown in FIG. 1 to FIG. 7 are performed first, and a photoresist layer 42 covering the top surface 13A and the tunnels 28A is formed on the ferroelectric substrate 12. Subsequently, a lithographic process is performed using a mask 50 having an opaque masking layer 56 with a plurality of transparent openings 52 therein. The positions of the transparent openings 52 correspond to the tunnels 28A such that a portion of the photoresist layer 42 in the tunnels 28A is exposed by the exposing beams 54 transmitting the transparent regions 52, as shown in FIG. 13.

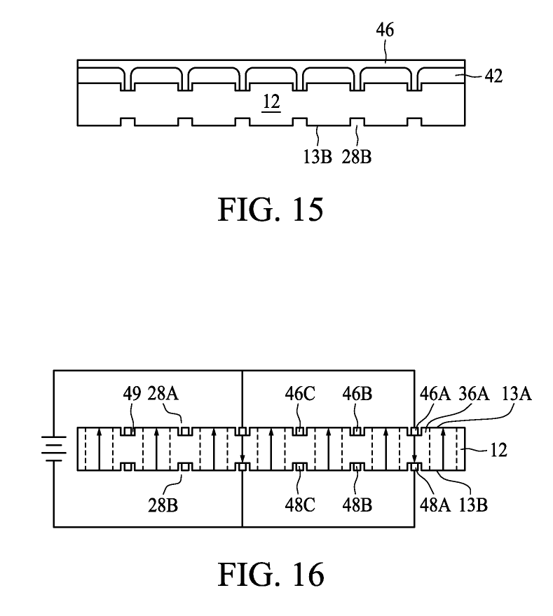

Referring to FIG. 14, since only a portion of the photoresist layer 42 in the tunnels 28A is exposed, a subsequent developing process can selectively remove the exposed portion of the photoresist layer 42 to form a plurality of openings 44 in the photoresist layer 42 in the tunnels 28A. Particularly, the openings 44 are separated from the sidewall of the tunnels 28A by the photoresist layer 42, and expose only a portion of the base surfaces of the tunnel 28A in the ferroelectric substrate 12. Subsequently, a conductive layer 46 covering the photoresist layer 42 and the tunnels 28A, i.e., filling the openings 44 in the photoresist layer 42, is formed by a deposition process, as shown in FIG. 15.

Referring to FIG. 16, a lift-off process is performed to remove the photoresist layer 42 and a portion of the conductive layer 46 on the photoresist layer 42, while the other portion of the conductive layer 46 remaining in the tunnels 28A forms a plurality of conductive blocks 46A, 46B and 46C in the tunnels 28A. Similar processes are performed to form a plurality of conductive blocks 48A, 48B and 48C in the tunnels 28B. Subsequently, a predetermined voltage is applied to the conductive blocks 46A in the tunnels 28A and the conductive blocks 48A in the tunnels 28B.

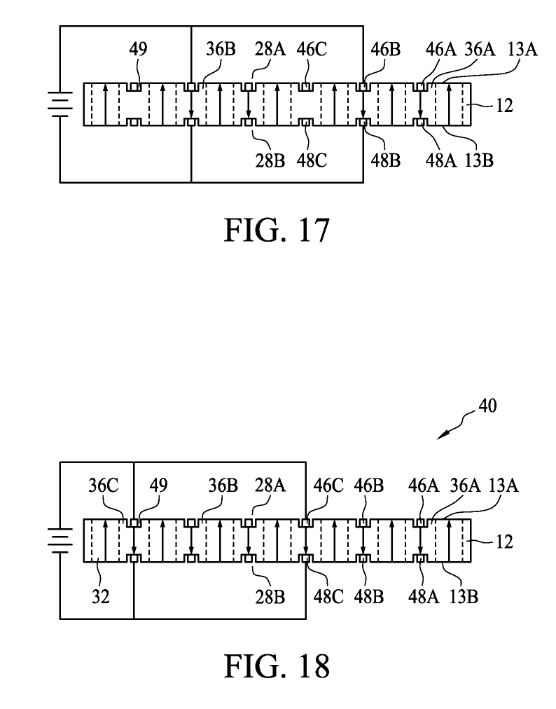

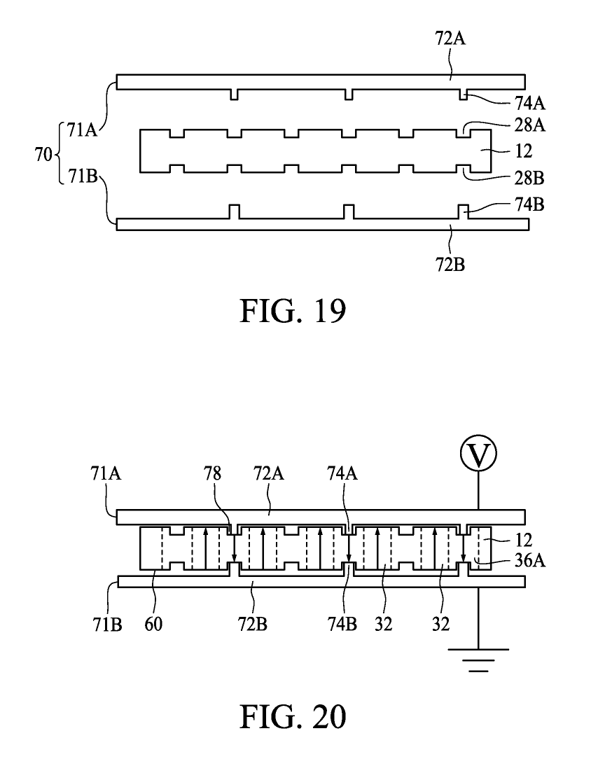

Referring to FIG. 17 and FIG. 18, the predetermined voltage is then applied to the conductive blocks 46B in the tunnels 28A and the conductive blocks 48B in the tunnels 28B to form a plurality of first domains 36B in the ferroelectric substrate 12. Again, the predetermined voltage is applied to the conductive blocks 46C in the tunnels 28A and the conductive blocks 48C in the tunnels 28B to form a plurality of first domains 36C in the ferroelectric substrate 12 to complete the periodically poled structure 40. The periodically poled structure 40 comprises a plurality of first domains 36A, 36B and 36C having a first polarization direction in the ferroelectric substrate 12 and a plurality of second domains 32 interleaved between the first domains 36A, 36B and 36C in the ferroelectric substrate 12. In conclusion, the poling process is segmented into two sub-poling processes, which can precisely control the width of the poled domains of the periodically poled structure 40.

In comparison with the periodically poled structure 10, shown in FIG. 11, in which the conductive blocks 30A, 30B and 30C cover the base surfaces of the tunnels 28A entirely, the periodically poled structure 40 in FIG. 18 has the conductive blocks 46A, 46B and 46C each separated from the sidewall of the tunnels 28A by insulation gaps 49 such as air gaps. Since there is no electric field extending from the sidewall of the conductive blocks 46A, 46B and 46C to that of the tunnels 28A, the method shown in FIG. 12 to FIG. 18 allows more precise control of the widths of the second domains 32.

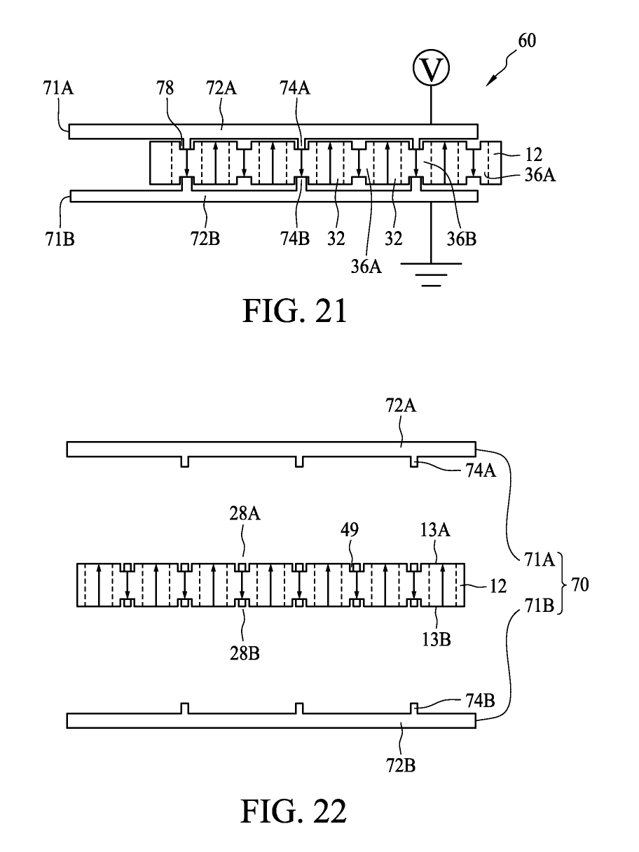

FIG. 19 and FIG. 22 illustrate a method for preparing a periodically poled structure 60 according to a third embodiment of the present invention. The processes shown in FIG. 1 to FIG. 7 are performed first, and a predetermined voltage is applied to the ferroelectric substrate 12 via an electrode element 70 including a top electrode 71A and a bottom electrode 71B to complete the periodically poled structure 60. The top electrode 71A includes a first conductive body 72A and a plurality of first conductive protrusions 74A positioned on the first conductive body 72A, and the bottom electrode 71B includes a second conductive body 72B and a plurality of second conductive protrusions 74B positioned on the second conductive body 72B, wherein the first conductive protrusions 74A are arranged in correspondence to the tunnels 28A in the ferroelectric substrate 12 and the second conductive protrusions 74B are arranged in mirror image of the first conductive protrusions 74A.

Preferably, the widths of the first conductive protrusions 74A and the second conductive protrusions 74B are smaller than those of the tunnels 28A and 28B, and each first conductive protrusion 74A is separated from the sidewall of the tunnel 28A by insulation gaps 78. Particularly, the widths of the first conductive protrusions 74A are equal and the first conductive protrusions 74A are separated equally, and the same is true for the second conductive protrusions 74B. In addition, vacuum pumps can be used to pump free electrons and air to improve the contact between the electrode element 70 and the ferroelectric substrate 12.

Also shown in FIG. 20, the top electrode 71A and the bottom electrode 71B are moved to a first contact position such that the first conductive protrusions 74A contact the base surfaces of a portion of tunnels 28A in the ferroelectric substrate 12 and the second conductive protrusions 74B contact the base surfaces of a portion of tunnels 28B. Subsequently, the top electrode 71A is connected to the predetermined voltage and the bottom electrode 71B is grounded such that a plurality of first domains 36A having a first polarization direction are formed in the ferroelectric substrate 12.

Referring to FIG. 21, the top electrode 71A and the bottom electrode 71B are moved to a second contact position such that the first conductive protrusions 74A contact the base surfaces of the other portion of tunnels 28A in the ferroelectric substrate 12 and the second conductive protrusions 74B contact the base surfaces of the other portion of tunnels 28B. Subsequently, the top electrode 71A is connected to the predetermined voltage and the bottom electrode 71B is grounded such that a plurality of first domains 36B having the first polarization direction are formed in the ferroelectric substrate 12. In conclusion, the poling process is segmented into two sub-poling processes, which can precisely control the width of the poled domains of the periodically poled structure 60. Furthermore, the method may further comprise a step of forming a plurality of conductive blocks in the tunnels 28A and 28B, and the first conductive protrusions 74A and 74B are positioned to contact the conductive blocks in the tunnels 28A and 28B, as shown in FIG. 22.

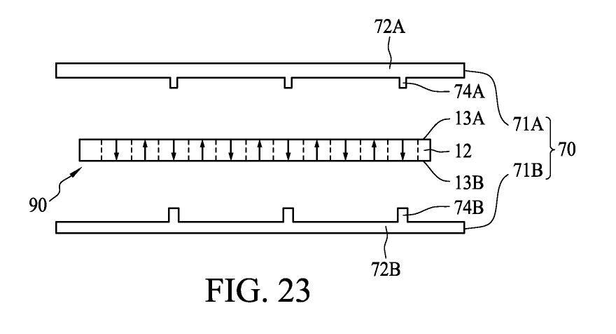

FIG. 23 illustrates a method for preparing a periodically poled structure 90 according to a fourth embodiment of the present invention. In comparison to the method in FIG. 15 which uses the conductive protrusions 74A and 74B of the electrode element 70 to contact the tunnels 28A and 28B of the ferroelectric substrate 12, the method in FIG. 23 uses the conductive protrusions 74A and 74B of the electrode element 70 to contact the top surface 13A and the bottom surface 13B of the ferroelectric substrate 12 without the tunnels 28A and 28B. After the predetermined voltage is applied to the top electrode 71A and the bottom electrode 71B is grounded, the ferroelectric substrate 12 possesses periodically poled domains 32A and 32B with alternating polarization directions.

The above-described embodiments of the present invention are intended to be illustrative only. Numerous alternative embodiments may be devised by those skilled in the art without departing from the scope of the following claims.

What is claimed is:

1. A method for preparing a periodically poled structure, comprising the steps of:
forming a plurality of tunnels in a ferroelectric substrate;
forming a plurality of first conductive blocks and second conductive blocks in the tunnels;
applying a predetermined voltage to the first conductive blocks such that a plurality of first domains having a first polarization direction are formed in the ferroelectric substrate; and
applying the predetermined voltage to the second conductive blocks such that a plurality of second domains having the first polarization direction are formed in the ferroelectric substrate between the first domains.

2. The method for preparing a periodically poled structure of claim 1, wherein the step of forming a plurality of first conductive blocks and second conductive blocks in the tunnels comprises:
depositing a conductive layer covering the ferroelectric substrate and the tunnels; and
removing a portion of the conductive layer from the ferroelectric substrate such that the conductive layer remaining in the tunnels forms the conductive blocks.

3. The method for preparing a periodically poled structure of claim 2, wherein the conductive layer remaining in the tunnels covers the base surfaces of the tunnels.

4. The method for preparing a periodically poled structure of claim 1, wherein the step of forming a plurality of first conductive blocks and second conductive blocks in the tunnels comprises:
forming a photoresist layer having a plurality of openings exposing a portion of the ferroelectric substrate;
depositing a conductive layer covering the ferroelectric substrate and the photoresist layer; and
removing a portion of the conductive layer covering the photoresist layer such that the conductive layer covering the ferroelectric substrate forms the conductive blocks in the tunnels.

5. The method for preparing a periodically poled structure of claim 4, wherein the openings in the photoresist layer expose a portion of the base surfaces of the tunnels.

6. The method for preparing a periodically poled structure of claim 5, wherein the openings are separated from the sidewalls of the tunnels by the photoresist layer.

7. The method for preparing a periodically poled structure of claim 1, wherein the tunnels are formed on a top surface and on a bottom surface of the ferroelectric substrate.

8. The method for preparing a periodically poled structure of claim 1, wherein the first conductive blocks and the second conductive blocks are positioned in an interlaced manner.

9. The method for preparing a periodically poled structure of claim 1, wherein the first conductive blocks and the second conductive blocks are positioned in an equally-spaced manner.

10. The method for preparing a periodically poled structure of claim 1, further comprising a step of applying the predetermined voltage to third conductive blocks between the first conductive blocks and the second conductive blocks such that a plurality of third domains having the first polarization direction are formed in the ferroelectric substrate between the first domains and the second domains.

11. A method for preparing a periodically poled structure, comprising the steps of:
positioning an electrode element to a first contact position of a ferroelectric substrate, the electrode element including a first conductive body and a plurality of first conductive protrusions positioned on the first conductive body;
applying a predetermined voltage to the electrode element such that a plurality of first domains having a first polarization direction are formed in the ferroelectric substrate;
positioning the contact element to a second contact position of the ferroelectric substrate; and
applying the predetermined voltage to the electrode element such that a plurality of second domains having the first polarization direction are formed in the ferroelectric substrate between the first domains.

12. The method for preparing a periodically poled structure of claim 11, further comprising a step of forming a plurality of tunnels in the ferroelectric substrate, and the first conductive protrusions being positioned into the tunnels in the ferroelectric substrate.

13. The apparatus for preparing a periodically poled structure of claim 12, wherein the widths of the first conductive protrusions are smaller than those of the tunnels in the ferroelectric substrate.

14. The apparatus for preparing a periodically poled structure of claim 12, wherein the first conductive protrusions are separated from the sidewalls of the tunnels by insulation gaps.

15. The method for preparing a periodically poled structure of claim 12, further comprising a step of forming a plurality of conductive blocks in the tunnels, and the first conductive protrusions being positioned to contact the conductive blocks in the tunnels.

16. The method for preparing a periodically poled structure of claim 15, wherein the step of forming a plurality of conductive blocks in the tunnels comprises:
depositing a conductive layer on a surface of the ferroelectric substrate; and
removing a portion of the conductive layer from the surface of the ferroelectric substrate such that the conductive layer remaining in the tunnels forms the conductive blocks.

17. The method for preparing a periodically poled structure of claim 16, wherein the conductive layer remaining in the tunnels covers the base surfaces of the tunnels.

18. The method for preparing a periodically poled structure of claim 15, wherein the step of forming a plurality of conductive blocks in the tunnels comprises:
forming a photoresist layer having a plurality of openings exposing a portion of the ferroelectric substrate;
depositing a conductive layer covering the ferroelectric substrate and the photoresist layer; and
removing a portion of the conductive layer covering the photoresist layer such that the conductive layer covering the ferroelectric substrate forms the conductive blocks in the tunnels.

19. The method for preparing a periodically poled structure of claim 18, wherein the openings in the photoresist layer expose a portion of the base surfaces of the tunnels.

20. The method for preparing a periodically poled structure of claim 19, wherein the openings are separated from the sidewalls of the tunnels by the photoresist layer.

21. The method for preparing a periodically poled structure of claim 12, wherein the tunnels are formed on a top surface and on a bottom surface of the ferroelectric substrate.

22. The method for preparing a periodically poled structure of claim 11, wherein the first domains and the second domains are positioned in an interlaced manner.

23. The method for preparing a periodically poled structure of claim 11, wherein the first domains and the second domains are positioned in an equally-spaced manner.

24. The method for preparing a periodically poled structure of claim 11, further comprising the steps of:
positioning the contact element to a third contact position of the ferroelectric substrate, the third contact position being between the first contact position and the second contact position; and
applying the predetermined voltage to the electrode element such that a plurality of third domains having the first polarization direction are formed in the ferroelectric substrate between the first domains and the second domains.
